(19) United States
(12) Patent Application Publication
(10) Pub. No.: US 2024/0308492 A1
(43) Pub. Date: Sep. 19, 2024

(54) Determination of a Retardation Quantity, In Particular a Feasible Retardation Quantity

(71) Applicant: KNORR-BREMSE Systeme fuer Nutzfahrzeuge GmbH, Muenchen (DE)

(72) Inventors: Daniel GEIS-ESSER, Muenchen (DE); Tobias SCHOEFBERGER, Mainburg (DE)

(21) Appl. No.: 18/681,243

(22) PCT Filed: Aug. 2, 2022
(86) PCT No.: PCT/EP2022/071753

§ 371 Date: Feb. 5, 2024

(30) Foreign Application Priority Data
Aug. 6, 2021 (DE) 10 2021 208 620.9

(51) Int. Cl. B60T 17/22

(52) U.S. Cl. CPC B60T 17/22; B60T 2210/12; B60T 2210/20; B60T 2250/02

(57) ABSTRACT

A method ascertains a deceleration quantity of a brake system of a vehicle, the brake system having at least one brake and at least one additional brake. The method involves the steps of: providing a value of a manipulated variable applied by the brake system, the at least one brake being configured to produce a deceleration quantity in response to the value of the manipulated variable; ascertaining a braking effect that has been applied to the brake system and acts on the vehicle by way of the brake system in response to the manipulated variable; ascertaining a deceleration quantity of the at least one brake, the deceleration quantity corresponding to the value of the manipulated variable and being obtained on the basis of a manipulated variable, in particular taking into account vehicle parameters; and ascertaining a deceleration quantity of the at least one additional brake from the deceleration quantity of the at least one brake and the braking effect on the vehicle, in particular taking into account vehicle parameters.

### BACKGROUND AND SUMMARY

The present invention relates to a method for determining a retardation quantity, in particular a feasible retardation quantity, of a brake, and also to an apparatus, a vehicle, a computer-program product and also a storage medium for carrying out the method.

As a result of the development of electrically powered vehicles and the associated possibility of achieving a braking effect on the vehicle by means of generative operation of the electric prime mover, attempts are being made to economize on conventional continuous-braking devices such as retarders, for example. By reason of the limited storage capacity of the corresponding electrical energy-storage units and the associated limited regenerative capability and consequently braking capability, on the one hand statutory regulations have been issued or are coming into being, according to which the driver, particularly in the field of utility vehicles, has to be informed about the braking efficiency of his/her vehicle, in which connection the mechanical brake, in particular, is discussed here. This brake comes into operation, at the latest, when no continuous-braking function is available, for example via the generative operation of the electric prime mover. In particular, efforts are therefore being made to inform the driver about the maximally feasible retardation of the vehicle. However, irrespective of this—that is to say, also in other types of road vehicle, such as conventionally powered vehicles or vehicles powered by hybrid means—there is also a need to be able to determine the braking efficiency as accurately as possible, in order, on the one hand, to be able to react during a driving situation and, on the other hand, also to make maintenance measures better, in particular more economical.

Present-day vehicles offer the possibility to ascertain the wear of the brake pads or linings crudely. For instance, the cumulative wear in the case of a disk brake—that is to say, the sum of the wear of both pads and also of the disk—is monitored. For this purpose, either a potentiometer comes into operation that responds as soon as the pad wear has advanced correspondingly, or use is made of a continuous potentiometer, the signal of which also permits inferences about the progress of the wear prior to total wear. Alternatively, use may also be made of a sliding contact; the latter takes effect if it has been exposed by wear.

It is contemplated that a determination of a retardation quantity—in particular, a feasible retardation quantity, for instance a braking torque or a braking force—or of a feasible vehicle retardation can be carried out for certain brakes on the vehicle; however, further brakes may be present that are excluded from this determination. For instance, a relatively elaborate determination of retardation quantities is dispensed with if appropriate parameters and/or manipulated quantities of these brakes are not known or cannot be determined, or if the corresponding brake is not being utilized permanently, as in the case of a lift axle. A further case of this may be the arrangement of the brake in a trailer.

The object of the present invention is therefore to present a possible way to be able to monitor also these further brakes.

This object is achieved by the subjects of the independent claims. Advantageous developments are subjects of the subordinate claims.

In the sense of this application, by a “feasible quantity”—such as a feasible manipulated quantity, a feasible retardation quantity or a feasible vehicle retardation—a quantity is to be understood that in terms of numerical value can be attained by the system under consideration, by the actuator under consideration, or such like. That is to say, by this expression the currently available range of values is meant, or, in concrete terms, a certain value from this range that the corresponding quantity may assume.

In the sense of this application, by a “trailer” any possible form of a trailer is to be understood. In particular, a “trailer” may comprise a semitrailer or a drawbar trailer. A towing vehicle may be a vehicle that is able to tow a trailer under its own power; however, it may also be a vehicle that, in turn, is being towed, in which case it can also tow a further trailer at the same time. In particular, in this case it may be a question of a dolly or a trailer that is designed to be coupled with a further trailer.

In accordance with the invention, a method is provided for determining a retardation quantity of a braking system of a vehicle, the braking system including at least one brake and at least one further brake, the method featuring the following steps:
providing a numerical value of a manipulated quantity that is supplied by the braking system, the at least one brake being designed to generate a retardation quantity in reaction to the numerical value of this manipulated quantity;
determining a braking effect acting on the vehicle by means of the braking system in reaction to the manipulated quantity that was impressed upon the braking system;
determining a retardation quantity, corresponding to the numerical value of the manipulated quantity, of the at least one brake that arises on the basis of the manipulated quantity, in particular taking vehicle parameters into account; and
determining a retardation quantity of the at least one further brake from the retardation quantity of the at least one brake and from the braking effect on the vehicle, in particular taking vehicle parameters into account.

By “retardation quantity”, a braking torque or a braking force that is generated by the at least one brake and/or by the at least one further brake in reaction to the manipulated quantity is preferentially to be understood.

The method according to the invention consequently comprises the determination of a corresponding retardation quantity of the at least one brake on the basis of a manipulated quantity that brings about this retardation quantity in the at least one brake—that is to say, that is generated by the brake. The determination is preferentially based on knowledge of the at least one brake—that is to say, a reaction of the at least one brake to the manipulated quantity is known. This may also include the fact that the current state of the at least one brake is known, for instance even when the efficiency of the at least one brake has already declined by reason of wear. This knowledge is lacking for the determination of the retardation quantity of the at least one further brake. This may, for instance, be due to the fact that, for reasons of cost, appropriate sensors for capturing required parameters—such as an actuator pressure, an actuator voltage or an actuator current—have been eliminated, for instance because the brake is not employed in the course of every braking action or because the brake is not permanently connected to a vehicle part, such as a trailer that is capable of being uncoupled, in which the determination of the retardation quantity of the at least one brake is carried out. Therefore the retardation quantity of the at least one further brake is inferred here indirectly via the actual braking effect—that is to say, the ultimate reaction of the vehicle to the braking action or to the supplied retardation quantities of the brakes.

The braking effect is preferentially determined by means of, or on the basis of, a vehicle retardation and/or by means of, or on the basis of, a vehicle speed. The vehicle retardation can, for instance, be captured by an appropriate acceleration sensor. If the vehicle speed is being considered, in particular a change in the vehicle speed by means of the braking system can be considered, or the vehicle speed can be taken into consideration as a controlled quantity, in which case, in particular, the numerical value of the manipulated quantity that is needed in order to keep the speed constant, for instance on a descending incline, is considered. The braking effect can accordingly be described, in particular, by a vehicle retardation and/or by a progression of the speed of the vehicle. In particular, the braking effect can be determined by consideration of the speed before and after the braking action, in particular by consideration of the difference in speed resulting therefrom.

The method preferentially also features the following steps:
providing a braking-system model that is designed to determine a retardation quantity of the at least one brake from an entered numerical value of the manipulated quantity;
entering the numerical value of the manipulated quantity into the braking-system model,
the determining of the retardation quantity of the at least one brake corresponding to the numerical value of the manipulated quantity being undertaken by the braking-system model.

In this case, a braking-system model is used for determining the retardation quantity of the at least one brake. The braking-system model being utilized is designed to map the behavior of the at least one brake of the vehicle onto an actual manipulated quantity having the corresponding numerical value.

Consequently a determination of the retardation quantity attained with a certain manipulated quantity is carried out.

In a further step of the method, a feasible retardation quantity of the at least one further brake is preferentially determined on the basis of the previously determined retardation quantity of the at least one brake and on the basis of a feasible manipulated quantity having a feasible numerical value. By virtue of the determined retardation quantity of the at least one further brake, a behavior of the at least one further brake, or a reaction thereof to a certain manipulated quantity, is known. From this, a feasible retardation quantity of the at least one further brake can be determined, in particular by extrapolation, if a technically feasible manipulated quantity having a numerical value that is consequently technically feasible is assumed. The feasible manipulated quantity can be supplied for all the brakes or only for some of the brakes, such as the at least one brake.

The feasible numerical value of the manipulated quantity preferentially encompasses a maximally feasible numerical value. This has the advantage that a maximally feasible retardation quantity can be determined in this way. That is to say, an assessment can be made at any time as to how strong or powerful the corresponding further brake still is, or is at the moment.

The feasible retardation quantity of the at least one brake is consequently determined by taking into account a manipulated quantity that is capable of being supplied during operation. That is to say, if the braking system is technically restricted during operation, for instance because an actuator for actuating the brake is defective, it can be taken into account that, by reason of the restricted manipulated quantity, a smaller retardation quantity is attainable. In addition, the retardation quantity that can be set by the feasible manipulated quantity—that is to say, the retardation quantity that is attainable—can be taken into account by the braking-system model. If a deterioration of the state of the brake is taken into account by the braking-system model, a feasible—that is to say, an attainable—retardation quantity can consequently be determined with the present method. This feasible retardation quantity of the at least one brake then serves as the basis for determining the feasible retardation quantity of the at least one further brake.

The feasible numerical value of the manipulated quantity preferentially comprises a numerical value of a contact force, of a tightening force, of an actuator force, of an actuator pressure, of an actuator current and/or of an actuator voltage. A contact force can generally describe the strength of pressing of a friction element against a corresponding counterpart. A tightening force can describe the strength of the tightening of the brake elements of a brake caliper against a brake disk. An actuator force can describe the force of an actuator that is designed to introduce this actuator force into the braking system. Such an actuator is preferentially actuated fluidically—that is to say, in particular, pneumatically or hydraulically—or electromechanically. Accordingly, an actuator pressure—that is to say, a fluidic pressure—or an actuator current or an actuator voltage can also be considered to be a manipulated quantity.

The braking system, or the at least one brake and/or the at least one further brake, preferentially includes a brake actuated fluidically, in particular pneumatically or hydraulically, and/or a brake actuated electromechanically.

The at least one brake and/or the at least one further brake of the braking system preferentially include(s) a friction brake. A friction brake may be, in particular, a drum brake or a disk brake. As a result of determining the retardation quantity of this brake, an assessment is made, for instance, concerning a braking torque that is generated by the brake.

The vehicle parameters that are taken into account when determining the retardation quantity, in particular of the at least one brake and/or of the at least one further brake, preferentially comprise a vehicle weight, a force-transmission capability between tires and road, an ascending incline, an operating state of a powertrain of a vehicle and/or an availability of other braking systems.

In general, a vehicle weight, a force-transmission capability between tires and road, an ascending incline, an operating state of a powertrain of the vehicle and/or the availability of other braking systems can also be used for determining other quantities by means of the method.

A vehicle weight may, for instance, comprise an unladen weight of the vehicle, an actual payload, an actual weight and/or a maximally permissible weight. For instance, a weight, such as the actual weight, can be determined by the vehicle itself, for instance by determination of the spring deflection in the compressed state or by means of appropriate force sensors. Additionally or alternatively, however, the taking of a weight into account can also be undertaken by means of an estimation or assumption of the corresponding weight. This may be the case, for instance, if a trailer has been coupled to a towing vehicle and its weight can merely be estimated or assumed but cannot be determined by means of measurement.

Furthermore, there may be provision that a weight is taken into account by means of input. For instance, a person can enter the known weight of a payload of the vehicle as an input quantity for the method. The vehicle weight can also be determined from an additional drive power that is necessary to accelerate the vehicle or to move it on an ascending gradient, in particular in comparison with the operation of the vehicle with a reference weight, for example with the unladen weight. A braking power, in particular a generative braking power, can also be used to infer the vehicle weight. In this case, the braking power is preferentially captured in the course of driving along a descending incline. Alternatively or additionally, the vehicle weight can also be taken from other vehicle systems, such as a suspension system, a stabilization system or a braking system (for example, EBS, ABS, ESP).

A force-transmission capability between tires and road is characterized primarily by the coefficient of friction between tires and road. This coefficient can be estimated, for instance, by means of known methods, or can be assumed to be a constant value.

The ascending incline can, for instance, be taken from digital map material or can be determined by means of measurement. This incline can be taken into account, for instance, with an ascending—gradient value or with an ascending-gradient angle. For the purpose of measurement, a capture of the inclination of the vehicle and/or acceleration sensors of the vehicle, for instance, may come into operation. In this connection, it should be taken into account that in the case of an ascending gradient—that is to say, a journey uphill—a lower limiting value may also be permissible, since here the downhill force assists a braking procedure or stopping procedure, despite a feasible retardation quantity that has been determined to be comparatively low. In contrast, a higher limiting value may find application on a descending gradient for the same feasible retardation quantity that has been determined. In this case, the downhill force would counteract a braking procedure or stopping procedure, so the braking system of the vehicle also has to compensate for the downhill force.

By an “operating state” of the powertrain, a transmission with which the powertrain is operated, for instance, may be understood. In the case of conventionally powered vehicles or vehicles powered by hybrid means, this may be the transmission with which an internal-combustion engine in coasting mode acts on the vehicle in retarding manner. In the case of an electrically powered vehicle, instead of an internal-combustion engine the electric prime mover, acting generatively, can act on the vehicle in retarding manner via the transmission. In the case of a vehicle powered by hybrid means, both the internal-combustion engine and an electrically powered prime mover can also act in retarding manner via the same transmission or via different transmissions. Furthermore, the operating state may include the current storage capacity of an electrical energy-storage unit. If, for instance, a braking effect is generated by an electric prime mover generatively, the energy arising can be stored therein only in the case of a sufficiently available current storage capacity of the corresponding energy-storage unit. If this is not possible, the generative brake can no longer be utilized if the energy arising cannot be consumed in some other way. In this case, the limiting value has to be lowered correspondingly.

Finally, by the “availability of other braking systems”, cases of damage, of wear and tear, but also the availability, described in the foregoing, of a generative brake or of a continuous service brake may be understood.

The at least one further brake has preferentially been provided in a further vehicle part which is connected in articulated manner to a first vehicle part. The further vehicle part may comprise a trailer or a semitrailer that is coupled with the first vehicle part. The first vehicle part may comprise a towing vehicle and/or a further trailer. However, there may also be provision that the two vehicle parts constitute an articulated vehicle that, in accordance with the design, is not coupled with a trailer and a towing vehicle. Such vehicles include, for example, buses, the front section (first vehicle part) and rear section (further vehicle part) of which are connected to one another in articulated manner.

A force measurement, in particular a coupling-force measurement, is preferentially undertaken between the first vehicle part and the further vehicle part. This can be done, for instance, by means of a capture means, in particular by means of a force sensor, at the coupling-point, which captures thrusts and tractive forces between the two vehicle parts. The information from the force measurement can then be used in order to infer the actual retardation quantity of the further brake. If the further vehicle part is arranged behind the first vehicle part in the direction of travel and if in the course of a braking action a thrust, for instance, is measured at the coupling-point, the further vehicle part is pushing the first vehicle part. If this thrust is higher than, for instance, a predetermined limiting value, or if this thrust does not correspond to the expected behavior, it can be inferred that the further brake is not attaining the retardation quantity that really corresponds to the manipulated quantity actually supplied. If a tractive force is measured at the coupling-point during a braking action, the further vehicle part is decelerating more intensely than the first vehicle part. If it can be inferred from the previous observation that the brakes at which a feasible retardation quantity is determined are intact, this is an indication that the at least one further brake is generating an excessive retardation quantity. This information may, however, also be utilized to infer that the brakes, the feasible retardation quantity of which is being determined, are in poor condition, so they are not attaining this retardation quantity.

The at least one further brake has preferentially been provided on a trailer and/or on a lift axle of the vehicle.

In general, a distribution of braking force can also be taken into account in the course of carrying out the method. If, for instance, it is known that certain brakes—for example, the brakes at the front of the vehicle—are receiving a manipulated quantity having a higher numerical value, the load on them can be taken into account by the braking-system model, and/or, if this is not possible, an indirect load can be determined through knowledge of the vehicle retardation, or of the braking effect and the known retardation quantities.

The braking-system model preferentially includes as further input quantity a temperature, in particular of the brake, a regulating distance and/or an actuation angle. For instance, the retardation quantity of the at least one brake can be determined by the braking-system model as a function of a temperature, in particular a temperature of friction elements of the at least one brake, such as, for example, of brake pads and/or of a brake disk. By virtue of a regulating distance and/or an actuation angle being taken into account by the braking-system model, the determination of the retardation quantity can be improved, and/or an assessment of wear pertaining to the at least one brake can also be made. Brakes that are subject to wear are actuated by mechanisms acting translationally and/or rotationally, in particular by transmission mechanisms, and/or by actuators. If the wear increases, this results in larger regulating distances and/or actuation angles. These can be captured, as a result of which an assessment of wear can be made. If the mechanisms or actuators exhibit adjusting appliances that are designed to even out the influence of the wear on regulating distance and/or actuation angle at least partially, it is also possible to determine the wear by capturing this adjustment—that is to say, in particular, by means of the numerical value by which the regulating distance and/or the actuation angle has/have been adjusted. Taking the regulating distance and/or the actuation angle into account may also include taking account of the fact that if the wear has advanced to such an extent a stop may be contacted and/or the regulating distance and/or the actuation angle may assume a maximally permissible value.

The method preferentially features a step in which a comparison of the determined feasible retardation quantity with a limiting value is carried out. The limiting value may, for instance, have been designed to be constant or variable. If it is established that the feasible retardation quantity of the at least one brake and/or of the at least one further brake is not attaining the limiting value, it has to be inferred therefrom that the state, in particular the state of wear, of the at least one brake and/or of the at least one further brake is no longer optimal. For instance, maintenance of the at least one brake and/or of the at least one further brake can then be provided. If a maximum retardation quantity having a maximally feasible manipulated quantity is determined, this maximum retardation quantity not attaining the corresponding limiting value, this represents a safety-critical problem which, under certain circumstances, also requires countermeasures during the journey. For instance, stopping of the vehicle can be forced.

Alternatively or additionally, the method features a step in which a determination of a feasible vehicle retardation from the determined feasible retardation quantity is carried out. Furthermore, a comparison of this feasible vehicle retardation with a corresponding limiting value can be undertaken. This limiting value may, for instance, have been designed to be constant or variable. Here too, the above considerations apply analogously. If, in particular, it is established that the maximally feasible vehicle retardation falls below a limiting value, a safety-critical problem exists which, under certain circumstances, also requires countermeasures during the journey. For instance, stopping of the vehicle can be forced.

Depending upon the result of the evaluation of the feasible retardation quantity and/or of the feasible vehicle retardation, a warning may also be output to the driver.

The limiting value and/or the feasible vehicle retardation is/are preferentially determined as a function of a vehicle weight, of a force-transmission capability between tires and road, of an ascending incline, of an operating state of a powertrain of a vehicle, and/or of the availability of other braking systems.

The braking-system model is preferentially updated on the basis of a history of braking interventions of the at least one brake. In order to improve the accuracy of the braking-system model, there may be provision that braking interventions, already carried out, of the at least one brake—that is to say, values relating to manipulated quantities actually supplied and to the braking effect resulting therefrom—are drawn upon in order to update the braking-system model. In particular, it is a question here of comparatively recent brake interventions, in order to base the update as far as possible on the current state of the at least one brake. However, there may be provision, additionally or alternatively, particularly if the braking-system model is being utilized in order to determine the maximally feasible retardation quantity of the at least one brake, that only braking actions that have a certain minimum numerical value of the manipulated quantity are taken into consideration. There is preferentially provision that the braking-system model is updated periodically or even permanently. Alternatively or additionally, there is provision that an unscheduled update is carried out. This may, for instance, be forced by the driver or triggered by changes to the vehicle, such as, for example, in the event of a change of load or of the vehicle configuration, for example by a vehicle part being exchanged, coupled or uncoupled.

The braking-system model preferentially exhibits a characteristic map and/or a physical model of the at least one brake. In particular, there may be provision that the braking-system model operates with a proportionality factor, for example a brake parameter, that permits a proportional conversion of manipulated quantity into retardation quantity. The proportionality factor may have been created as a constant value, may have been stored in a characteristic map, or may be calculated by means of a physical model. The proportionality factor may, in particular, have been fashioned to be dependent on the following input quantities, as were described above:
temperature, in particular of the brake,
regulating distance and/or
actuation angle.

Consequently a calculation of the retardation quantity of the at least one brake preferentially results, in accordance with the following relationship:

Retardation quantity=Proportionality factor*Manipulated quantity

The proportionality factor may include further parameters, such as, for example, a transmission ratio or an efficiency between the manipulated quantity and the retardation quantity. In the concrete case of the design of the at least one brake as a disk brake, a mean friction radius may also be taken into account or may already be included in the transmission ratio.

According to a further aspect of the invention, an apparatus is provided for carrying out the method described above, exhibiting
an interface for receiving input quantities;
an interface for outputting the retardation quantity, in particular the feasible retardation quantity, of the at least one brake and/or of the at least one further brake; and
a data-processing unit that is designed for carrying out the method described above.

Such an apparatus may, for instance, take the form of a brake control unit or may provide a part of the functionality of a brake control unit. But there may also be provision that the apparatus constitutes a higher-level, autonomous functional unit for brake monitoring, or a functional unit for brake monitoring that has been integrated into another device.

The data-processing unit preferentially includes electronic means for data processing.

According to a further aspect of the invention, a vehicle is provided for carrying out the method described above:
the vehicle being designed for carrying out the method described above, and/or exhibiting an apparatus described in the foregoing,
the vehicle preferentially taking the form of a utility vehicle, truck, trailer, bus and/or a combination of towing vehicle and trailer, and/or
the vehicle preferentially taking the form of a vehicle powered purely electrically, by hybrid means, or conventionally.

According to a further aspect of the invention, a computer-program product is provided, having program code that has been configured in such a way that, when it is executed in a data-processing unit, in particular in a data-processing unit mentioned in the foregoing, it induces the latter to execute the method described above. In this way, it is advantageously possible to give existing apparatuses and/or vehicles with data-processing units the appropriate capability so that they are then able to execute the method described above.

According to a further aspect of the invention, a storage medium with a computer-program product described in the foregoing is provided. In this way, it is possible to pass on the computer-program product easily, in order, for instance, to give apparatuses with data-processing units, or vehicles, the appropriate capability. An appropriate storage medium comprises, for instance, a CD-ROM, a memory stick, a memory card or even a cloud memory from which the computer-program product can be downloaded.

All the features that were used above in connection with the description of the method can be carried across analogously also to the further subjects constituted by apparatus, vehicle, computer-program product and storage medium. If a feature of these subjects has been mentioned directly in connection with the description of the method, this feature is to be understood to be an optional feature of the corresponding subject.

The invention will be elucidated in more detail in the following with reference to a particular embodiment example with the aid of the attached drawings.

### BRIEF DESCRIPTION OF THE DRAWINGS

FIG. 1 shows a basic structure of a brake, as well as the actuation thereof;

FIG. 2 shows parameters influencing the braking procedure, and

FIG. 3 shows a schematic top view of a vehicle.

### DETAILED DESCRIPTION OF THE DRAWINGS

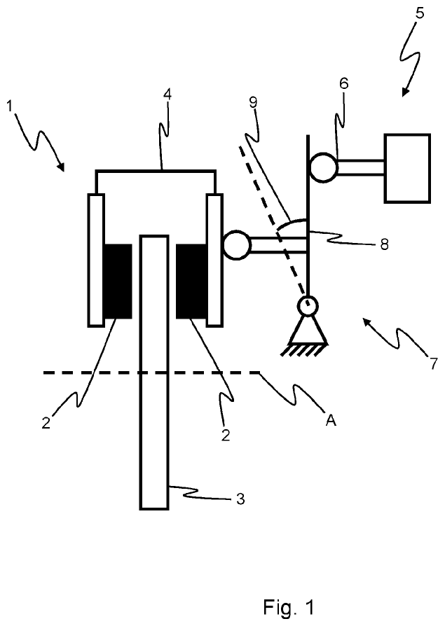

FIG. 1 shows a basic structure of a brake, as well as the actuation thereof.

Exact representation of all the components has been dispensed with here. The drawing in FIG. 1 shows merely a functional principle.

The brake 1 here takes the form of a friction brake which includes brake pads 2 and a brake disk 3 which is capable of rotating about an axis A. The brake pads 2 are provided in a brake caliper 4 which encloses the brake disk 3 on both sides. The brake pads 2 and the brake disk 3 serve as friction elements which can be brought into contact with one another in rubbing manner, in order to generate a retardation quantity.

An actuator 5 is provided for actuating the brake 1. This actuator has an actuating element 6 which can be displaced to the left in the drawing by translation.

Between the actuator 5 and the brake 1, a transmission mechanism 7 is provided which includes an actuating lever 8 that is designed to be capable of swiveling in the plane of the drawing. On the one hand, the transmission mechanism 7 is connected to the actuator 5, so that a displacement of the actuating element 6 into the transmission mechanism 7 is introduced, as a result of which the actuating lever 8 is swiveled counterclockwise. On the other hand, the transmission mechanism 7 is in contact with the brake 1, in order to introduce into the brake 1 a displacement or force that results from the displacement of the actuating element 6, in order to contact the brake pads 2 with the brake disk 3, in order in this way to generate the retardation quantity of the brake 1.

In the case of a disk brake, the retardation quantity may be a braking torque that results from a clamping force—that is to say, a force with which the brake pads 2 are pressed against the brake disk 3—and a mean friction radius.

By virtue of the transmission mechanism 7, there is a transmission ratio that describes the translation of an actuator force, or of the resulting displacement of the actuating element 6, into the clamping force.

For the purpose of determining a retardation quantity that is capable of being generated, or is generated, by the brake 1 in reaction to a manipulated quantity, a braking-system model may therefore have been provided that takes these factors into account. In certain embodiments, a proportionality factor is provided which reproduces a conversion of the manipulated quantity into the retardation quantity. If an efficiency—for instance, of the entire arrangement shown or of parts thereof—is known, a feasible braking force can be calculated, by a feasible manipulated quantity being input into the braking-system model:

$${M}_{B} = {c}^{*} \times i \times {F}_{Z} \times η \times {R}_{m}$$

M_{B}: retardation quantity
c*: proportionality factor
i: transmission ratio
F_{z}: actuator force (manipulated quantity)
η: efficiency
Rₘ: mean friction radius

The actuator 5 here is generally constrained. In some embodiments, the actuator 5 takes the form of a fluidically actuated actuator, in particular a pneumatically or hydraulically actuated actuator. According to other embodiments, the actuator 5 is electrically actuated—that is to say, a brake 1 actuated in such a manner is to be classed as an electromechanical braking system. In the case of fluidic actuation, the actuator 5 may exhibit a cylinder with a piston, in order to displace the actuating element 6 by means of pressure. In the case of electric actuation, the actuator 5 may exhibit a linear motor or a rotary electric motor, in which case the rotary motion thereof is then preferably transformed into a translational motion by means of an appropriate mechanism, in order to displace the actuating element 6.

According to other embodiments, the transmission mechanism 7 may be dispensed with. It is therefore also possible that the actuator 5, or the actuating element 6 thereof, acts on the brake 1 directly—that is to say, without transmission—and gives rise there to a pressing of the friction elements 2, 3 against one another.

Lastly, the brake 1 may also be based on a different technical or physical principle. For instance, a drum brake or a friction brake is contemplated which comes into contact with a friction element which is stationary with respect to the vehicle, such as a magnetic rail brake for instance.

The brake 1 described in the foregoing may, in the sense of this application, serve as the at least one brake, the retardation quantity of which can be determined, for instance with a braking-system model, on the basis of a manipulated quantity. However, the brake 1 may, in the sense of this application, also serve as the at least one further brake, the retardation quantity of which can be determined as in the case of the at least one brake, so this retardation quantity has to be inferred indirectly, by also considering the braking effect on the vehicle.

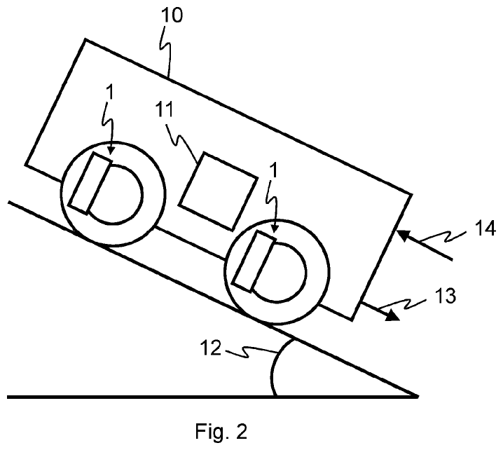

FIG. 2 shows, in a schematic representation, parameters influencing the braking procedure of a vehicle.

A vehicle 10 is shown which is moving on a descending incline that has the ascending-gradient angle 12. The latter can, for instance, be determined by measurement of inclination or by means of digital map material. In addition to an inclination angle 12, use may also be made of other suitable quantities, such as an ascending-gradient specification for instance.

The vehicle 10 has a powertrain 11 and brakes 1. The brakes 1 may have been designed in accordance with the brakes from FIG. 1. The powertrain 11, which here is illustrated only schematically, may be a conventional, hybrid or electric powertrain. For instance, the powertrain 11 influences the braking by means of electrical energy-storage units that are no longer receptive, so braking generatively can no longer be undertaken.

Furthermore, a downhill force 13 is shown. The latter depends on the ascending-gradient angle 12 and on the weight of the vehicle 10, which can be defined or determined as described above.

The vehicle retardation 14 is directed contrary to the downhill direction of travel. This vehicle retardation can be determined through knowledge of the feasible retardation quantity of the brake 1, or of the brakes 1, and of vehicle parameters such as a vehicle weight. If this vehicle retardation is too slight in comparison with a limiting value which, for instance, has been stipulated by legislation, suitable countermeasures have to be taken, such as a warning, maintenance, or even a termination of automotive operation.

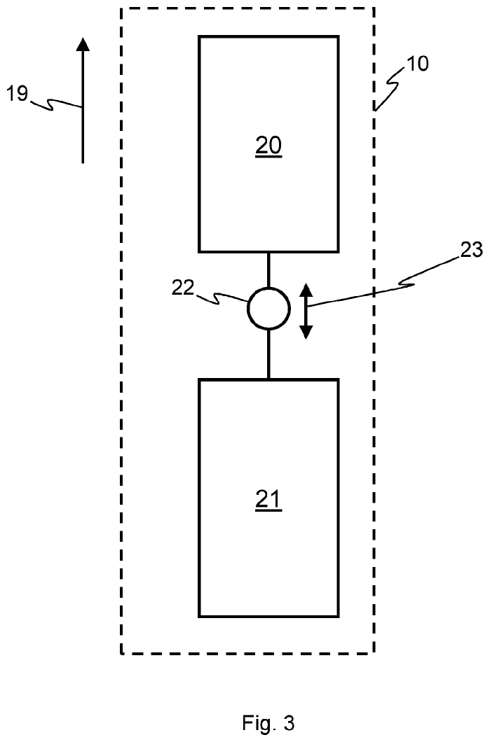

FIG. 3 shows a schematic top view of a vehicle.

The vehicle 10 comprises a towing vehicle 20 and a trailer 21, which are connected to one another at a coupling-point 22, so that the trailer 21 can be towed by the towing vehicle 20 in the direction of travel 19. The towing vehicle 20 and the trailer 21 each have at least one brake (not represented). The towing vehicle 20 constitutes a first vehicle part, which is connected in articulated manner to a further vehicle part, the trailer 21. The vehicle parts shown here are separably connected to one another. However, it is also contemplated that this connection is not designed to be separable—that is to say, the two vehicle parts do not serve as towing vehicle 20 and trailer 21 but constitute, for instance, a vehicle formed in an articulated manner, such as an articulated bus.

The coupling-point 22 is designed to ascertain—for instance by means of a means for capturing a coupling force, in particular by means of a coupling-force sensor—a coupling force 23 between the vehicle parts. In particular, an assessment concerning the braking effect of the vehicle parts can be made here.

If it is established that the coupling force 23 during a braking procedure permits a pushing of the rear vehicle part—in this case, the trailer 21—to be inferred, in the comparison of the two vehicle parts, a stronger braking or a stronger braking effect of the front vehicle part can be inferred. If, on the other hand, it is established that towing at the coupling-point 22 is beginning, this permits a stronger braking or a stronger braking effect of the rear vehicle part to be inferred.

If, for instance, the retardation quantity of the at least one brake can be determined only in one vehicle part—that is to say, only in the towing vehicle 20 or in the trailer 21—then on the basis of the coupling force 23 the retardation quantity of the at least one brake of the vehicle part that cannot be captured by the braking-system model can be inferred, by the actual braking effect in the course of a braking action being determined as described above, and by the retardation quantity of the at least one brake of this vehicle part being inferred from the coupling force 23 in the case of a known manipulated quantity, or a known numerical value of the manipulated quantity.

### LIST OF REFERENCE SYMBOLS

1 brake
2 brake pads
3 brake disk
4 brake caliper
5 actuator
6 actuating clement
7 transmission mechanism
8 actuating lever
9 actuation angle
10 vehicle
11 powertrain
12 ascending-gradient angle
13 downhill force
14 vehicle retardation
19 direction of travel
20 towing vehicle
21 trailer
22 coupling-point
23 coupling force
A axis

1.-15. (canceled)

16. A method for determining a retardation quantity of a braking system of a vehicle, the braking system including at least one brake and at least one further brake, the method comprising the steps of:
providing a numerical value of a manipulated quantity that is supplied by the braking system, the at least one brake being designed to generate a retardation quantity in reaction to the numerical value of this manipulated quantity;
determining a braking effect acting on the vehicle by way of the braking system in reaction to the manipulated quantity that was impressed upon the braking system;
determining the retardation quantity, corresponding to the numerical value of the manipulated quantity, of the at least one brake that arises based on the manipulated quantity, taking vehicle parameters into account; and
determining a retardation quantity of the at least one further brake from the retardation quantity of the at least one brake and from the braking effect on the vehicle, taking vehicle parameters into account.

17. The method as claimed in claim 16, further comprising the steps of:
providing a braking-system model that is designed to determine the retardation quantity of the at least one brake from the input numerical value of the manipulated quantity;
entering the numerical value of the manipulated quantity into the braking-system model;
wherein the determining of the retardation quantity of the at least one brake corresponding to the numerical value of the manipulated quantity is undertaken by the braking-system model.

18. The method as claimed in claim 16, wherein
a feasible retardation quantity of the at least one further brake is determined based on a previously determined retardation quantity of the at least one further brake and based on a feasible retardation quantity having a feasible numerical value of the manipulated quantity.

19. The method as claimed in claim 18, wherein
the feasible numerical value of the manipulated quantity encompasses a maximally feasible numerical value of the manipulated quantity.

20. The method as claimed in claim 16, wherein
the at least one brake and/or the at least one further brake of the braking system include(s) a friction brake.

21. The method as claimed in claim 16, wherein
the vehicle parameters that are taken into account when determining the retardation quantity of the at least one brake and/or of the at least one further brake comprise one or more of:
a vehicle weight,
a force-transmission capability between tires and road,
an ascending incline,
an operating state of a powertrain of the vehicle, or
an availability of other braking systems.

22. The method as claimed in claim 16, wherein
the at least one further brake is provided in a further vehicle part which is connected in an articulated manner to a first vehicle part, wherein
a force measurement is undertaken between the first vehicle part and the further vehicle part.

23. The method as claimed in claim 16, wherein
the at least one further brake is provided on a trailer and/or on a lift axle of the vehicle.

24. The method as claimed in claim 17, wherein
the braking-system model includes as a further input quantity a temperature of the at least one brake, a regulating distance, and/or an actuation angle.

25. The method as claimed in claim 17, wherein
the braking-system model is updated based on a history of braking interventions.

26. The method as claimed in claim 17, wherein
the braking-system model exhibits a characteristic map and/or a physical model of the at least one brake.

27. An apparatus for determining a retardation quantity of a braking system of a vehicle, the braking system including at least one brake and at least one further brake, comprising:
an interface for receiving input quantities;
an interface for outputting a retardation quantity of the at least one further brake and/or of the at least one brake; and
a data-processing unit operatively configured to:
provide a numerical value of a manipulated quantity that is supplied by the braking system, the at least one brake being designed to generate a retardation quantity in reaction to the numerical value of this manipulated quantity;
determine a braking effect acting on the vehicle by way of the braking system in reaction to the manipulated quantity that was impressed upon the braking system;
determine a retardation quantity, corresponding to the numerical value of the manipulated quantity, of the at least one brake that arises based on the manipulated quantity, taking vehicle parameters into account; and
determine a retardation quantity of the at least one further brake from the retardation quantity of the at least one brake and from the braking effect on the vehicle, taking vehicle parameters into account.

28. A vehicle, comprising:
an apparatus according to claim 27,
wherein the vehicle is a utility vehicle, truck, trailer, bus, and/or a combination of towing vehicle and trailer, and/or
wherein the vehicle is a purely electrical vehicle, a hybrid vehicle, or an internal combustion engine vehicle.

29. A computer product comprising a non-transitory computer readable medium having program code stored thereon which, when executed in a data-processing unit, carries out the acts of:
providing a numerical value of a manipulated quantity that is supplied by the braking system, the at least one brake being designed to generate a retardation quantity in reaction to the numerical value of this manipulated quantity;
determining a braking effect acting on the vehicle by way of the braking system in reaction to the manipulated quantity that was impressed upon the braking system;
determining a retardation quantity, corresponding to the numerical value of the manipulated quantity, of the at least one brake that arises based on the manipulated quantity, taking vehicle parameters into account; and
determining a retardation quantity of the at least one further brake from the retardation quantity of the at least one brake and from the braking effect on the vehicle, taking vehicle parameters into account.
